(19) United States
(12) Patent Application Publication
(10) Pub. No.: US 2026/0008635 A1
(43) Pub. Date: Jan. 8, 2026

(54) APPARATUS AND METHOD FOR TRANSPORTING PIECE GOODS WITH TRANSPORT SWITCHES

(71) Applicant: KRONES AG, Neutraubling (DE)

(72) Inventors: Andreas SORGE, Rimbach (DE); Patrick KOEHLER, Geisling (DE); Diego Javier SARMIENTO SANCHEZ, Regensburg (DE); Helmut SCHUESSLBURNER, Straubing (DE)

(21) Appl. No.: 19/262,628

(22) Filed: Jul. 8, 2025

(30) Foreign Application Priority Data
Jul. 8, 2024 (DE) 10 2024 119 274.7

(51) Int. Cl. B65G 47/68; B65G 47/26; B65G 47/82

(52) U.S. Cl. CPC B65G 47/682; B65G 47/26; B65G 47/82; B65G 2201/0235

(57) ABSTRACT

Apparatus for transporting piece goods, in particular containers (10) or container packs, comprising a supply device (2) which is suitable for supplying the piece goods along at least one first supply path (Z) to a distribution region (B), and comprising a discharge device (4) which is suitable for discharging the piece goods either along at least one first discharge path (A1) or one second discharge path (A2), wherein the apparatus comprises a first distribution device (6) which is movable between at least two positions (P1, P2), wherein the first distribution device (6) is suitable and intended for pushing the piece goods toward the first discharge path (A1) when the distribution device (6) is arranged in the first position (P1) and for pushing or guiding the piece goods toward the second discharge path when the first distribution device (6) is arranged in the second position (P2).

The present invention relates to an apparatus and to a method for transporting piece goods, in particular containers. Transporting piece goods, in particular containers, container packs or the like has long been known in the prior art. It is often necessary, for example, to distribute containers or container packs across different transport lanes. Different apparatuses and methods are known for this purpose.

It is therefore known to distribute containers or container packs by means of flaps. It is also known to distribute containers or container packs using segment switches.

Apparatuses and methods known in the prior art comprise a region in which the guidance of the containers is interrupted. This interruption in lane guidance can lead to jamming of the containers at this point, which in turn can lead to the system stopping.

EP 0 585 685 B1 describes an apparatus for transferring a stream of containers in a row arriving in a single lane onto several transport tracks. A switching point is provided which serves as a sliding surface and whose downstream end facing the single lane arriving stream of containers can be adjusted essentially transversely to the conveying direction. This switching point is designed to be flexible, at least in sections.

WO 97/19873 A1 discloses an apparatus for discharging individual rotationally symmetrical containers.

EP 0 624 532 A11 describes an apparatus for sorting bottles or containers, comprising a sorting region formed by at least one two-track transport path.

WO 2018/166 700 A1 discloses an apparatus for distributing containers transported on a transport apparatus.

EP 4 335 793 A1 describes an electrically operated segment ejector. A plurality of pushing segments are provided, which can be placed in the transport path of the containers.

An apparatus for ejecting transported goods is known from DE 10 2009 040 604 A1.

The object of the present invention is to provide an apparatus and a method for transporting piece goods, in particular containers, which in particular reduce the risk of jamming and also enable faster transportation of piece goods, in particular containers.

The containers are particularly preferably plastics bottles, pulp bottles, pouches, glass bottles or their workpiece carriers. The liquid in the containers is in particular a beverage, for example beer, wine, lemonade, juices, spirits, water, or a product from the healthcare or pharmaceutical sector.

According to the invention, these objects are achieved by the subject matters of the independent claims. Advantageous embodiments and developments are the subject matter of the dependent claims.

An apparatus according to the invention for transporting piece goods, in particular containers or container packs, comprises a supply device which is suitable and intended for supplying the piece goods along a first supply path to a distribution region. The supply device comprises a first transport device which is suitable and intended for moving the piece goods along the supply path (in particular actively). Active movement is understood to mean, in particular, a movement caused by a drive device, as opposed to, for example, a movement caused by gravity.

Furthermore, the apparatus comprises a discharge device which is suitable and intended for discharging the piece goods either along at least one first discharge path or one second discharge path (and/or to supply them either to a first discharge path or a second discharge path), wherein the discharge device comprises at least one transport device which is suitable and intended for moving the piece goods (in particular actively) along the first or second discharge path.

It is possible for each of the discharge paths to be assigned a transport device in the form of a transport belt or a transport chain, but it would also be conceivable for both discharge paths to be assigned a common transport device, in particular in the form of a transport belt or a transport chain.

Furthermore, the apparatus has a first distribution device which is movable between at least two positions, wherein the first distribution device is suitable and intended for pushing the piece goods toward the first discharge path when the distributor device is arranged in the first position, and for pushing or guiding the piece goods to the second discharge path when the distribution device is arranged in the second position.

Pushing is understood to mean that the piece goods are actually actively separated into a position and that the distribution device therefore does not only exhibit guiding or neutral behavior in the corresponding position.

Preferably, the distribution device or a pushing surface thereof therefore causes the piece goods to move transversely and/or perpendicularly to their transport direction.

Guidance is understood to mean that the containers are in particular not pushed or moved perpendicularly to the transport path, but are held in a specific transport path and no, or at most a slight, displacement can occur transversely to the transport path.

The invention thus proposes a distribution device which, in particular depending on its position, can either push the piece goods into one of the two discharge paths or (in particular in the other position) can guide the piece goods in such a way that they cannot leave a certain transport direction (or however likewise push the piece goods into the other transport path).

This guidance ensures in particular that piece goods do not become jammed even at higher transport speeds. However, it would also be conceivable for the distribution device to push the piece goods into one discharge path or the other, depending on its position.

Preferably, the transport device and/or the supply device form(s) a first transport lane within which the piece goods are transported. In addition to a transport chain or a transport belt, two (in particular stationary) side walls can also be provided which laterally delimit this transport lane.

Preferably, a transport lane is also formed on at least one discharge path and preferably on (each of) the two discharge paths, which is particularly preferably delimited in each case by lateral (and in particular stationary) walls.

Preferably, exactly one supply path is provided. In a further preferred embodiment, exactly two discharge paths are provided. However, it would be possible, for example, for a discharge path itself to in turn act as a supply path and branch into two or more discharge paths.

In a particularly preferred embodiment, the first and/or the second transport devices, and in particular the first and second transport devices, are transport belts or transport chains. However, it would also be possible for only one transport device, in particular a transport belt or a transport chain, to be provided, which transports the piece goods not only in the region of the supply path but also in the region of the discharge path(s).

In particular, the piece goods are containers, in particular filled and in particular sealed (by a container closure) containers. However, the piece goods can also be packs made up of a plurality of containers.

The containers may in particular be plastic containers or glass containers.

In a further preferred embodiment, the distribution device comprises a lower surface which is preferably arranged above a transport surface, in particular a transport belt or a transport chain. A lower surface is understood to be a surface of the distribution device(s) that faces downward in the vertical direction.

Particularly preferably, this lower surface of the distribution device does not touch the transport device, in particular a transport belt or a transport chain. In this way, the distribution device is not pushed into the transport direction of the piece goods by the transport device.

Particularly preferably, this lower surface of the transport device is a flat surface, in particular a horizontally extending surface.

Particularly preferably, said lower surface is at a distance from the transport device, in particular the transport belt or the transport chain, of greater than 1 mm, preferably greater than 2 mm, preferably greater than 3 mm, preferably greater than 4 mm. Particularly preferably, the lower surface of the distribution device is at a distance from the transport device, in particular the transport belt or the transport chain, of less than 10 cm, preferably less than 8 cm, preferably less than 6 cm, preferably less than 4 cm, preferably less than 3 cm, preferably less than 2 cm and preferably less than 1 cm.

This can ensure that the distribution device is not placed under strain by the action of a force device in the transport direction.

In a further preferred embodiment, the distribution device is linearly displaceable between the two positions. In particular, the distribution device can be moved in a straight line between the two positions. However, it would also be possible to pivot the distribution device about a predetermined pivot axis. This could in particular be a pivot axis which runs near a tip of a wedge-shaped distribution device.

In a further advantageous embodiment, a transport lane for transporting the piece goods is formed in or at one position of the distribution device, which extends from the supply path to the first or second discharge path for the piece goods, and a transport lane for transporting the piece goods is formed in or at a second position of the distribution device, which extends from the supply path to the second or first discharge path for the piece goods, wherein the distribution device forms, in each of the positions, at least a section of a limiting wall of each of these transport lanes.

Preferably, at least one transport lane is delimited, at least in sections, by lateral walls and/or by stationary walls. In a further advantageous embodiment, at least one transport lane is delimited, at least in sections, by the distribution device.

In a further advantageous embodiment, the supply device has at least one lateral limiting device and in particular a lateral limiting wall which delimits the movement of the piece goods transversely to the transport path.

Particularly preferably, the apparatus comprises a limiting wall (which laterally delimits the transport path of the piece goods) which is at least partially formed by the distribution device.

Particularly preferably, the transport device is arranged between a first treatment device and a second treatment device, wherein the first and the second treatment devices treat the piece goods, in particular containers, in different ways.

In a further preferred embodiment, the distribution device can move between the first position and the second position transversely to the transport direction of the piece goods. Transversely is understood to mean that this movement does not take place in the transport direction, but at a predetermined angle thereto.

This angle is particularly preferably greater than 30°, preferably greater than 40°, preferably greater than 50°, preferably greater than 60°, preferably greater than 70° and preferably greater than 80°.

In a further advantageous embodiment, the first distribution device has a first pushing surface which is suitable and intended for pushing the piece goods toward the first discharge path, and a second pushing and/or guide surface which is suitable and intended for pushing the piece goods toward the second discharge path or to guide them (on the way to the second discharge path), wherein the first pushing surface and the second pushing or guide surface are spaced apart from one another, at least in sections.

Preferably, the first pushing surface extends obliquely to a movement path of the piece goods, which said goods would take in the absence of the distribution device.

In this embodiment, it is proposed that the piece goods are pushed into the first discharge path and the piece goods are pushed into the second discharge path or the piece goods are guided toward the second discharge path by the same distribution device, in particular by different surfaces of this distribution device.

In a further preferred embodiment, in at least one position of the distribution device, at least one pushing surface extends obliquely to the transport path (imaginary transport path not influenced by the distribution device) of the piece goods. In the second position, the second pushing and/or guide surface particularly preferably extend parallel to the transport path of the piece goods. It would, however, also be conceivable for the second pushing or guide surface in the second position of the distribution device to also extend obliquely to the (imaginary) transport path of the piece goods (not influenced by the distribution device).

It is therefore proposed that the or each pushing or guide surface, depending on the position of the distribution device, also acts as a conventional guide surface, which does not push the piece goods but rather keeps them in a specific transport path. A pushing surface is understood to mean that the piece goods are actively pushed or moved, in particular transversely to the transport.

In a preferred embodiment, the pushing surface is coated, in particular to reduce frictional resistance between said surface and the transported piece goods. Particularly preferably, the pushing surface of the apparatus and/or of the distribution device is exchangeable.

Particularly preferably, the positions described above are positions of the distribution device. Preferably, these positions or at least one of the positions is/are adjustable in order to achieve an adaption, for example, to different piece goods, in particular different containers, in particular bottles.

In a further preferred embodiment, the first pushing surface is suitable and intended for pushing the piece goods into the first discharge path (or toward the first discharge path) when the distribution device is arranged in the first position. The second pushing or guide surface is advantageously suitable and intended for pushing the piece goods into the second discharge path or for guiding them to the second discharge path when the distribution device is arranged in the second position.

In a further preferred embodiment, in one position of the distribution device, at least one pushing surface, in particular the second pushing and/or guide surface, acts as a guide surface.

In a further advantageous embodiment, the distance between the first pushing surface and the second pushing or guide surface increases in the transport direction of the piece goods. Particularly preferably, the distribution device is wedge-shaped.

Particularly preferably, a maximum distance between the first pushing surface and the second pushing and/or guide surface is less than the length of the distribution device. Particularly preferably, a maximum distance between the first pushing surface and the second pushing and/or guide surface is greater than 2 cm, preferably greater than 3 cm, preferably greater than 4 cm, preferably greater than 5 cm, preferably greater than 6 cm and particularly preferably greater than 10 cm.

Particularly preferably, a maximum distance between the first pushing surface and the second pushing and/or guide surface is less than 40 cm, preferably less than 35 cm, preferably less than 30 cm, preferably less than 25 cm and particularly preferably less than 20 cm.

Preferably, the pushing surface and the pushing and/or guide surface extend toward one another in the opposite direction to the transport direction of the piece goods.

The invention allows containers or container packs to be distributed between two tracks. The distribution device, which is in particular a wedge segment switch, is preferably designed in such a way that in both directions after the switching of the individual segment(s) or distribution devices, a the lane guidance being provided (substantially) continuous on both sides. Substantially continuous is understood to mean that any remaining gaps in the lane guidance are smaller than a diameter of the containers to be transported, preferably smaller than half of this diameter and particularly preferably smaller than a quarter of this diameter.

The distribution device or wedge segment switch preferably has at least two segments. This means that at least two distribution devices are preferably arranged, in particular one after the other, in the transport device of the piece goods. However, these two distribution devices together preferably cause the distribution of the piece goods to one discharge path or to the other.

In particular, a gap in the container stream is required in order to switch (or move) these distribution devices. For this reason, the apparatus particularly preferably comprises a gap-creating device which is suitable and intended for creating a gap in a container stream. For example, the gap-creating device can be a holding device that briefly stops the transported containers (and also containers behind them). Preferably, this gap-creating device is suitable and intended for creating gaps of different sizes.

Particularly preferably, the gap-creating device is arranged upstream of the distribution device and/or upstream of the distribution region in a transport direction of the piece goods.

Particularly preferably, the apparatus comprises a control device which is suitable and intended for controlling the movement of the distribution device between the first position and the second position, taking into account an activation of the gap-creating device and/or on the basis of a position of a created gap.

Preferably, this control device is also suitable and intended for taking into account a transport speed of the transported piece goods, in particular containers, when controlling the movement of the distribution device. Preferably, the control device is suitable and intended for controlling a movement of the distribution device(s) on the basis of the size and/or “transport speed” of the gap.

For example, it is possible for the gap-creating device to stop a piece good and subsequent piece goods from continuing to be transported, thus creating an increasing gap from the piece goods that continue to be transported. As soon as this gap has reached the (first) distribution device, this can be moved to the respectively other position.

Preferably, the control device is suitable and intended for controlling the distribution device and/or the gap-creating device in such a way that a minimal gap is created and/or a gap that still allows safe movement of the distribution device(s).

The more segments the distribution device has or the more distribution devices there are, the shorter will be the gap required to switch the individual segments or distribution devices.

In a further advantageous embodiment, the apparatus comprises a drive device which is suitable and intended for moving the distribution device between the first position and the second position, wherein this drive device is preferably arranged at least partially (and preferably completely) above or below the transport devices.

Particularly preferably, this drive device is arranged above or below the transport path of the containers, particularly preferably above the transport path.

In this way, the movement of the piece goods, in particular containers, is not disturbed by the drive device.

The drive device is preferably an electrical or a pneumatic drive device. In particular, the drive device is a linear motor, in particular a position-controlled linear motor, or the drive device comprises a linear motor. Preferably, the drive device comprises a carriage which is movable in particular in a straight line relative to a guide device and is movable in particular between two end positions.

These end positions are preferably adaptable and/or adjustable when different container diameters are being processed. Preferably, however, no mechanical modifications are necessary to achieve this adaptation, in particular as a result of the provision of an electric motor and in particular a linear motor.

The positions can preferably be determined by a control means, for example a bottle selector switch and/or a production recipe. However, a fully automatic changeover would also be conceivable, for example if the apparatus detects a new container format and makes or changes the corresponding settings in response to this new container format.

In a preferred embodiment, at least one of the positions and preferably both positions (P1, P2) is/are adjustable. Preferably, this adjustment can be carried out semi-automatically or automatically. This means in particular that no mechanical conversion work needs to be carried out, but these positions can be adjusted by a drive device, for example. It would also be possible to change these positions by adjusting the drive device, such as a linear motor. For example, the end positions can be changed using a control device.

Preferably, further parameters, such as a width of the transport lane(s), can also be adjusted automatically.

In a further preferred embodiment, the drive device has a linkage which projects in particular vertically upward to the actual drive device and/or which connects the distribution device to the carriage described above.

In a further preferred embodiment, the distribution device is arranged in a rotationally fixed manner on the drive device.

In a further preferred embodiment, the drive device is preferably arranged entirely above the distribution device.

In a further advantageous embodiment, the apparatus comprises a second distribution device which is arranged upstream or in particular downstream of the first distribution device in the transport direction of the piece goods, wherein this second distribution device is also movable between a first position and a second position.

Preferably, this second distribution device directly follows the first distribution device in the transport direction of the piece goods. Particularly preferably, a movement of this second distribution device can be controlled independently of the movement of the first distribution device.

Particularly preferably, the second distribution device is also wedge-shaped. Particularly preferably, the second distribution device is shaped such that the first and second distribution devices collectively also form a wedge shape.

Particularly preferably, this second distribution device also has a first pushing surface and a second pushing and/or guide surface.

In the further preferred embodiment, the apparatus has a third distribution device which is suitable and intended for pushing and/or guiding the piece goods into the first or into the second discharge path.

In a further advantageous embodiment, the apparatus has at least three, preferably at least four, distribution devices, which are preferably arranged one after the other in the transport direction of the piece goods or which preferably form at least one continuous pushing surface, at least temporarily.

Particularly preferably, the drive device is directly mechanically connected to the distribution device. It would also be possible to provide a mechanical element, such as a toggle lever, between the drive device, for example a linear motor, and the distribution device in order to reduce the switching time. For example, such a toggle lever (mechanism) can engage each distribution device and/or each segment.

However, it would also be possible to provide the drive device as a toothed belt drive or spindle drive. A spindle drive with a rapid pitch could also be provided.

Furthermore, different configuration variants in which the distribution device can be used are possible. For example, a “Y-formation” is possible. Here several parallel transport lanes are provided. An h-configuration is also possible. There several parallel transport belt tracks are provided. In addition, an h-configuration is also conceivable for small differences in the diameter of the individual container types. In addition, it is also possible to provide two transport belt tracks. This will be explained below with reference to the drawings.

Due to the two-sided lane guidance proposed here, jamming cannot occur in a switch region. For example, lying containers can travel safely through the switch region. In all the variants described, only a small adjustment of the individual distribution devices or segments is possible with a small container diameter (up to 73 mm diameter, for example) and a high system throughput. This means that high system throughput can be achieved even with a short adjustment stroke.

For large container diameters (in particular above 73 mm and up to 122 mm) and low system throughputs, a larger adjustment stroke is possible or necessary. In this case, the system throughput is lower, but the adjustment stroke is larger.

It is possible in each case to design the distribution device in a similar way to lane guidance or to carry out the discharge paths. No frame parts are required.

The present invention further relates to a method for transporting piece goods, in particular containers or container packs, wherein a supply device supplies the piece goods along at least one, preferably exactly one, first supply path to a distribution region, wherein this supply device has a first transport device which moves the piece goods—in particular actively—along the supply path and wherein at least one discharge device discharges the piece goods either along at least one first discharge path or along one second discharge path, wherein the discharge device has at least one transport device which moves the piece goods—in particular actively—along the first or second discharge path, wherein the apparatus has a first distribution device which is moved between at least two positions, wherein the first distribution device pushes the piece goods toward the first discharge path when the distribution device is arranged in the first position and pushes or guides the piece goods toward the second discharge path when the first distribution device is arranged in the second position.

The containers are particularly preferably transported separately. Particularly preferably, the containers are supported at their bottom and transported and/or moved—in particular actively—for example by a transport belt or a transport chain.

In a further advantageous method, a second distribution device is also moved between a first position and a second position, wherein the second distribution device is moved independently of the movement of the first distribution device and/or the movement of the second distribution device is not coupled to the movement of the first distribution device.

Preferably, the second distribution device also has a first pushing surface and a second pushing and/or guide surface, which in particular perform the same function as the corresponding surfaces of the first distribution device.

Particularly preferably, the first and the second distribution devices are directly arranged one after the other in the transport direction of the piece goods.

Particularly preferably, a piece goods stream is interrupted, at least temporarily, in particular in order to carry out the movement of the at least one distribution device.

Particularly preferably, the containers are guided and/or pushed transversely to the transport device or devices.

Further advantages and embodiments can be seen in the accompanying drawings.

in which:

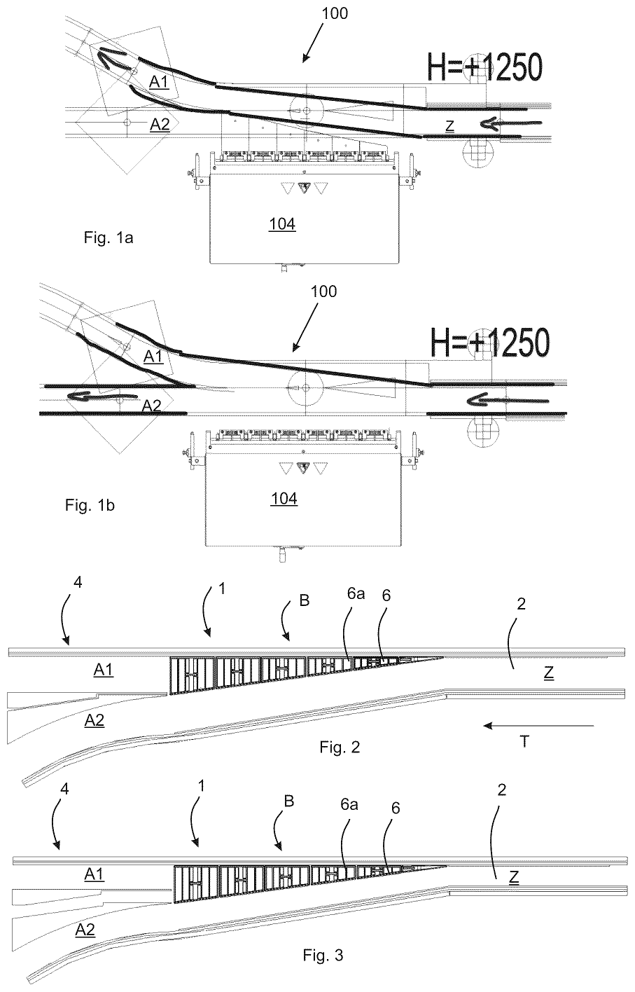

FIGS. 1a, 1b show two representations of an apparatus according to the prior art;

FIG. 2 shows a schematic representation of an apparatus according to the invention in a first embodiment;

FIG. 3 shows the present invention in a second embodiment;

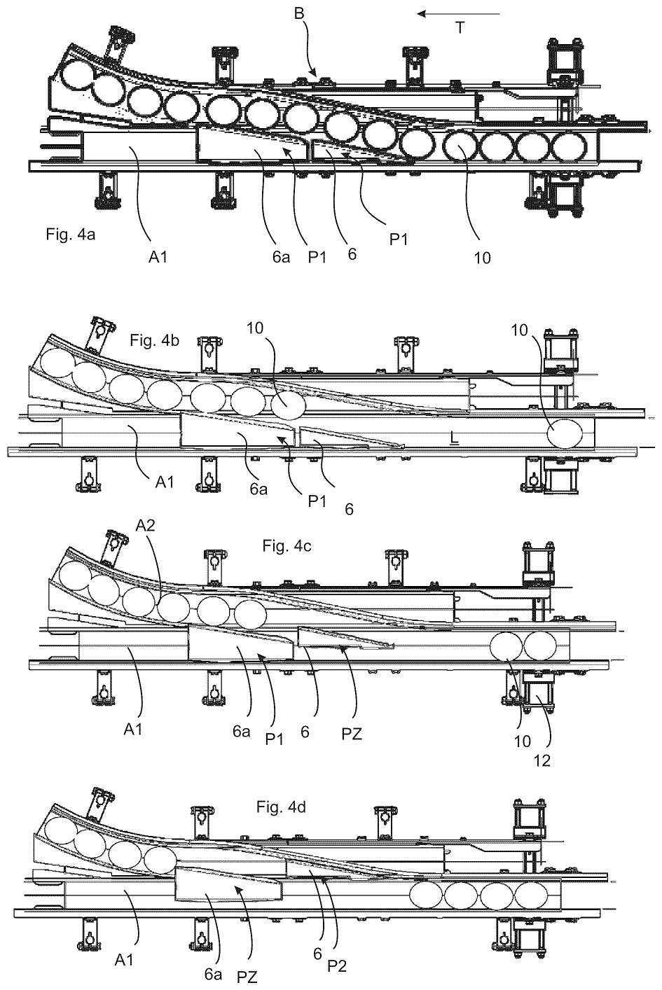

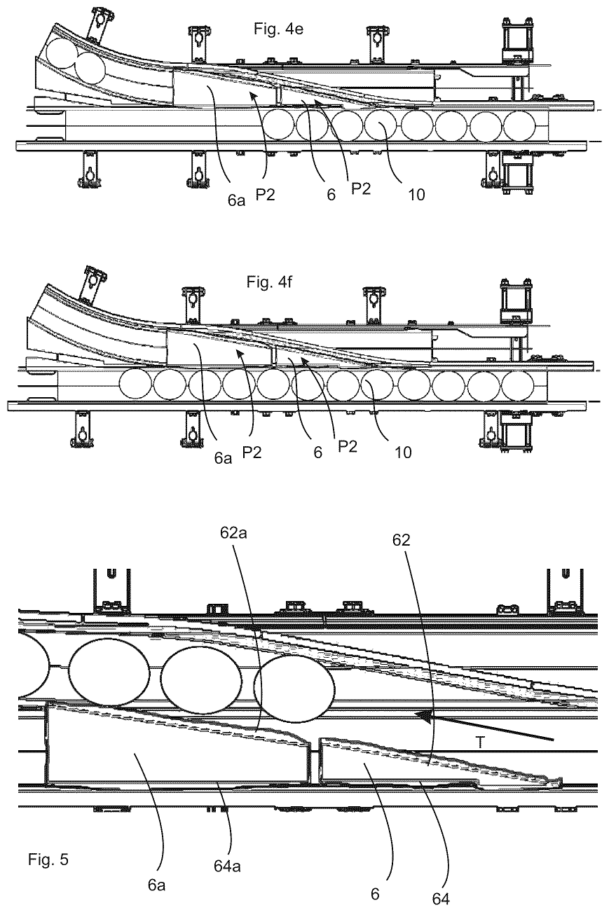

FIGS. 4a-4f show representations of a method according to the invention;

FIG. 5 shows a representation illustrating the distribution device;

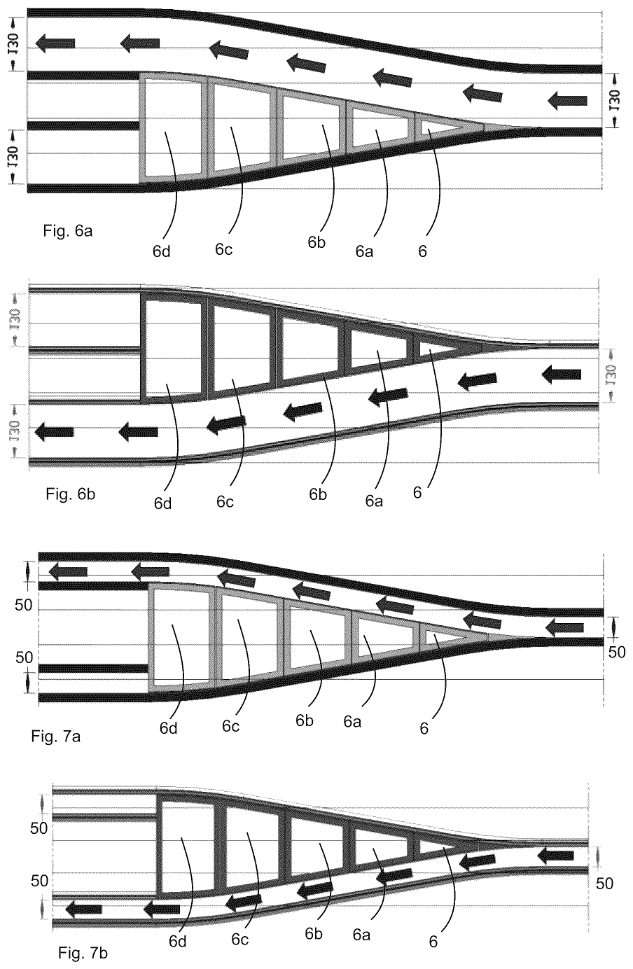

FIGS. 6a, 6b show a distributor device in a further embodiment;

FIGS. 7a, 7b show the distributor device in a further embodiment;

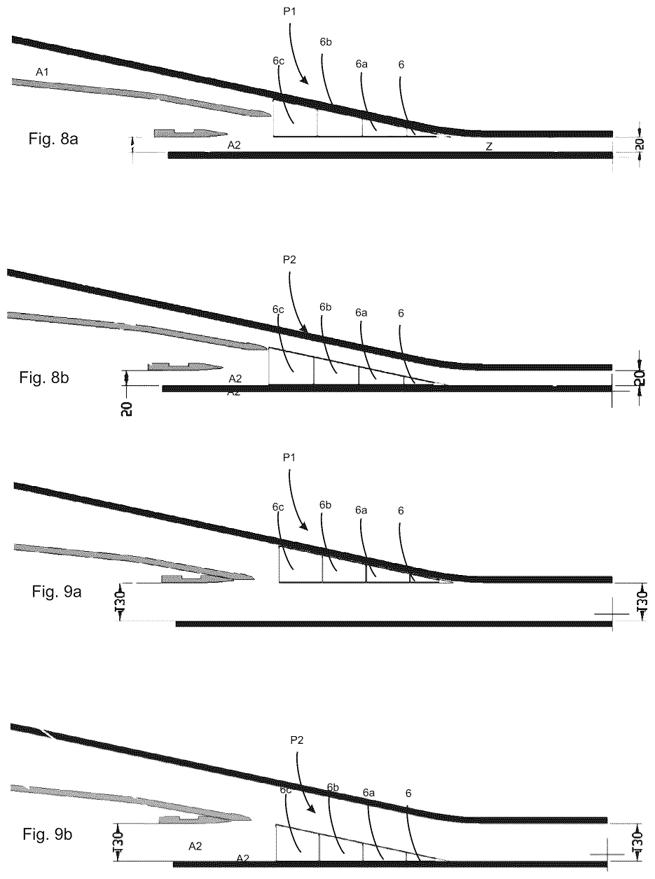

FIGS. 8a, 8b show two representations illustrating the invention;

FIGS. 9a, 9b show two representations of the invention in a further embodiment;

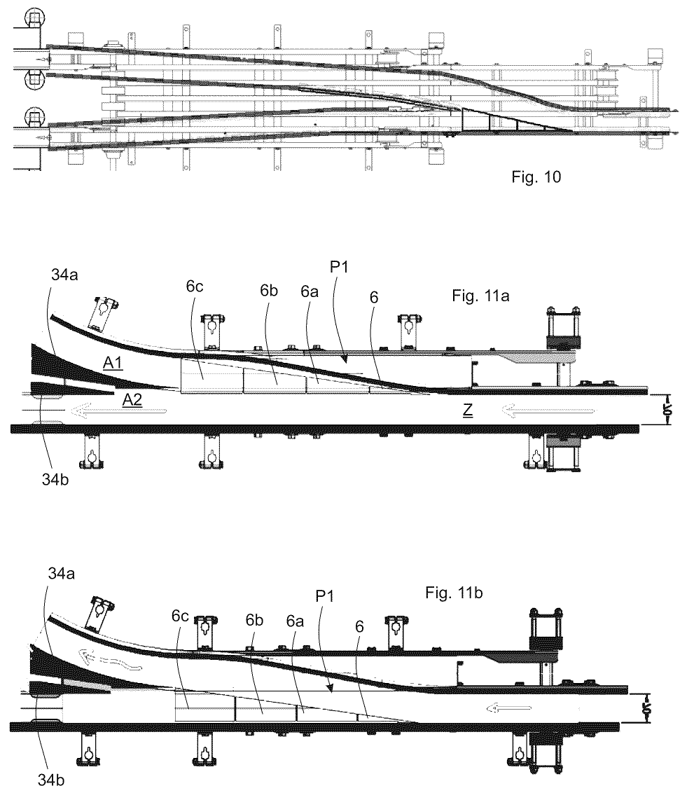

FIG. 10 shows a further representation of the present invention;

FIGS. 11a, 11b show representations illustrating the present invention;

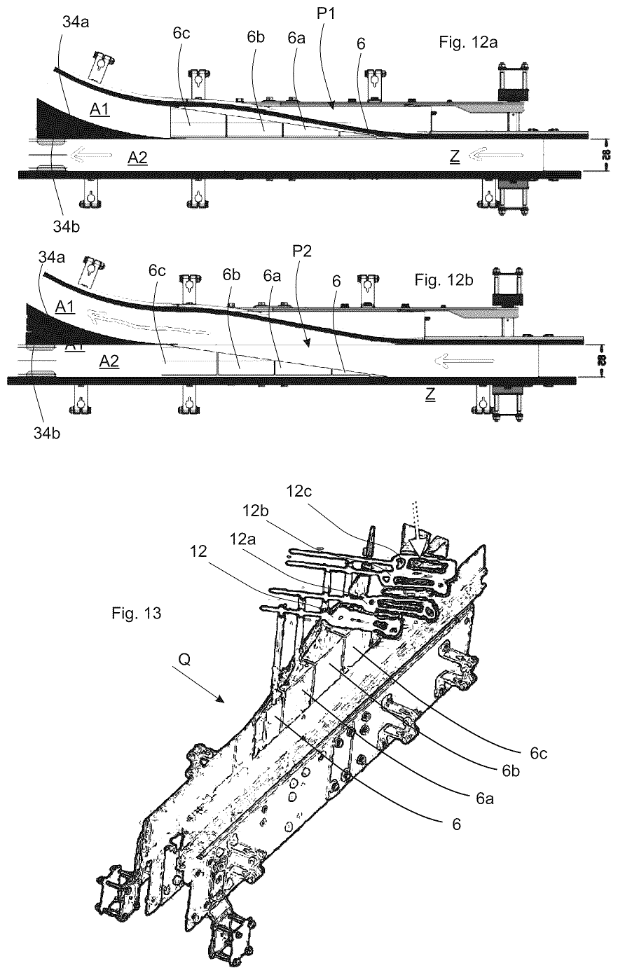

FIGS. 12a, 12b show two further representations illustrating the invention;

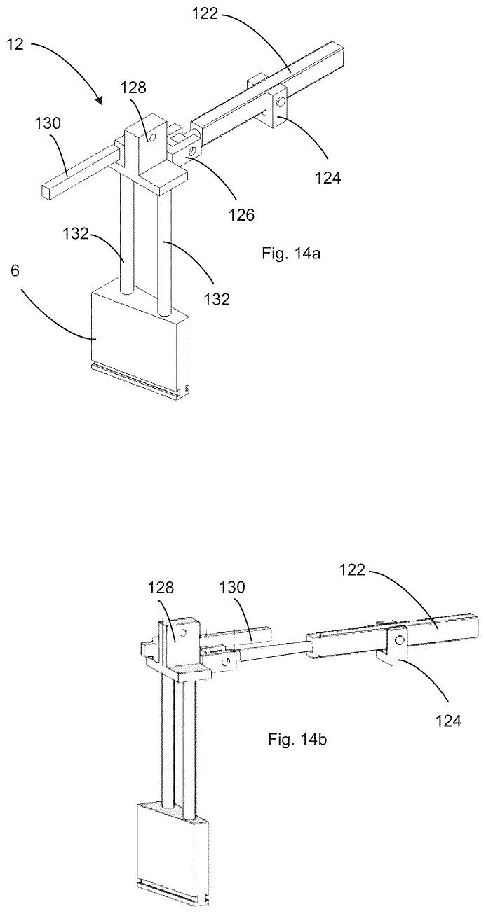

FIG. 13 shows a perspective view of the apparatus according to the invention;

FIGS. 14a, 14b show two representations of a drive device for the present apparatus;

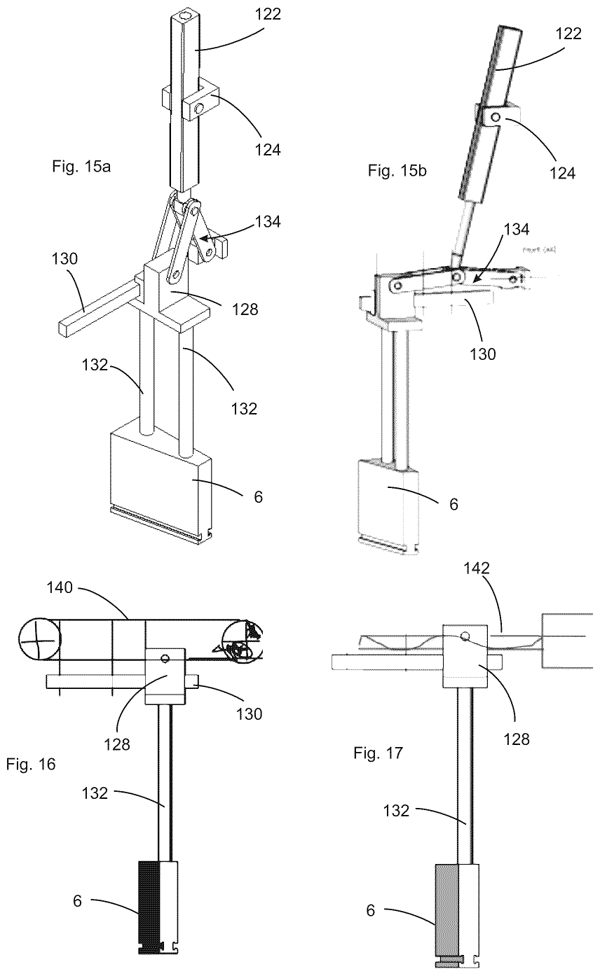

FIGS. 15a, 15b show further representations of a drive device;

FIG. 16 shows a further embodiment of a drive device;

FIG. 17 shows a further embodiment of the drive device; and

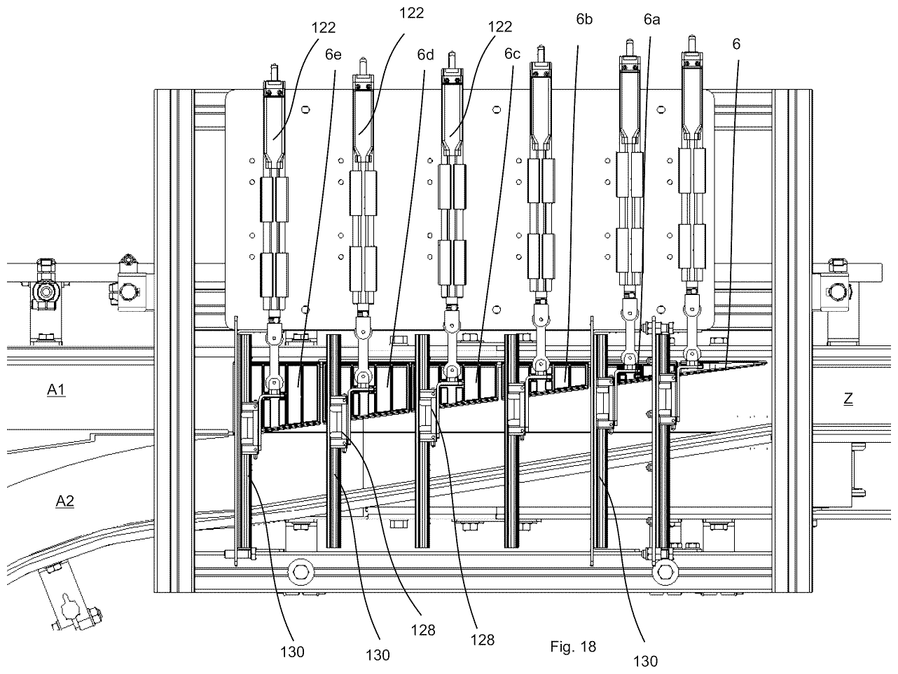

FIG. 18 shows a plan view of the apparatus according to the invention.

FIG. 1a shows an apparatus for transporting according to the prior art. A supply region Z is provided, in which containers are supplied to a distribution region. In this sub-region, the containers can be guided out onto two discharge paths A1 and A2. For this purpose, a distribution device 104 is provided, which, in the illustration shown in FIG. 1, is positioned such that the containers are directed toward the first discharge path A1. In the situation shown in FIG. 1b, the containers are guided toward the second discharge path A2.

It can be seen that in the situation shown in FIG. 1b the distribution device is not active or has been reset. However, this can therefore lead to containers unintendedly changing position between the two discharge paths A1 and A2 and, for example, becoming jammed in the discharge path.

It can also be seen that the distribution device in this figure is arranged next to the transport path of the containers; in this way, the individual distribution segments only have a surface which serves to guide the containers.

FIG. 2 is a schematic view of an apparatus according to the invention. Here, a supply region Z is again provided, which can comprise a transport belt and which conveys upright piece goods, in particular containers here, from right to left (in the direction of arrow T).

The piece goods (not shown) can be transported into the first discharge path A1 or the second discharge path A2.

For this purpose, several distribution devices 6, 6a are provided here, which, in the situation shown in FIG. 2, are positioned such that the piece goods or containers are directed toward the second discharge path A2. This means that in this case the containers are transported in a transport lane which, on the one hand, is delimited by side walls, but, on the other hand, is also partially delimited by the individual distribution devices.

Preferably, this discharge path is completely closed laterally. However, if the individual distribution devices 6, 6a, . . . are each moved downward (in the figure), the containers are conveyed in a straight line toward the first discharge path A1. In this case, a corresponding transport lane extends straight from right to left. However, in this case too, a section of this transport lane is partially formed by the distribution devices 6, 6a, . . .

FIG. 3 shows a similar situation to that in FIG. 2, but here containers with a smaller cross-section are processed or transported. Reference sign B denotes the distribution region in which the containers are distributed between the two discharge paths A1 and A2.

Preferably, the apparatus has an adjustment device for adjusting to different container diameters. For example, the respective lane widths can be changed for different container diameters. Both, manual and also an automated adjustment is possible.

FIGS. 4a to 4f illustrate a method according to the invention.

In the situation shown in FIG. 4a, piece goods, in this case containers 10, are conveyed into a discharge region A2. For this purpose, it can be seen that transport belts are provided, which again transport the containers from right to left here.

Reference signs 6 and 6a denote two distribution devices which are arranged in a distribution region B. Both distribution devices are located in a position P1 in this case, in which the containers are conveyed into the discharge region A2.

In the situation F shown in FIG. 4b, a gap L is created between the transported containers 10. The distribution devices 6 and 6a are still in the lower position, i.e. position P1.

In the situation shown in FIG. 4c, the distributor device 6 is pushed or moved (in relation to the figure) upward, i.e. in the direction of the second position P2, i.e. it is located in an intermediate position PZ in FIG. 4c, but is moved upward into position P2. The distribution device 6 should have reached this position before the next containers arrive at said device.

In the situation shown in FIG. 4d, the distribution device 6 is already in the upper or second position P2 and the second distribution device 6a is in an intermediate position. This is possible in this situation because the distribution device 6a also is not (yet) directing or pushing any containers.

In the situation shown in FIG. 4e, both distribution devices 6 and 6a are in the upper position P2. The containers are now transported in a straight line from right to left into the discharge path or discharge region A1. FIG. 4f shows that all containers are now being transported into the discharge path or discharge region A1.

FIG. 5 shows a detailed representation of the distribution devices 6 and 6a. The first distribution device 6 has a first pushing surface 62 and a second pushing and/or guide surface 64 (which, however, acts as a guide surface in the embodiment shown in FIG. 5). The second distribution device 6a comprises a first pushing surface 62a and a second pushing and/or guide surface 64a.

The pushing surfaces 62 and 64 on the one hand and the pushing and guide surfaces 62a and 64a on the other hand are spaced apart from one another. The distance between these surfaces increases in the transport direction T, i.e. from right to left here. Both distribution devices 6 and 6a thus form a wedge shape together and here collectively form a pushing surface, which, in the situation shown in FIG. 5, conveys the piece goods toward the discharge path A2.

FIG. 6a shows a further representation of the apparatus according to the invention. A total of five distribution devices 6, 6a, 6b, 6c and 6d are provided here, each of which can also be moved between two positions. In the situation shown in FIG. 6a, the containers are guided or pushed into the second discharge path A2. When the individual distribution devices are moved to the upper position (cf. FIG. 6b), the containers are guided, or more precisely pushed, into the first discharge path A1. In the situation shown in FIG. 6a, b, two surfaces of the individual distribution devices each act as pushing surfaces because they also move or push the individual containers transversely to the transport direction.

The apparatus in 6a, b is suitable for transporting comparatively large containers and has a lane width of 130 mm in this case.

In the situation shown in FIG. 7a, b, containers with a relatively small diameter, here a diameter of 50 mm, can be transported.

FIGS. 6b and 7b each show the situations in which the distribution devices are in the upper position and thus the containers are transported toward the second discharge paths A2.

The representations shown in FIGS. 6a, b and 7a, b can thus each be referred to as a Y design, since the overall shape of the supply and discharge paths has a Y-like structure.

In the situation shown in each of FIGS. 8a, b and 9a, b, an H-shaped design is provided in which the first discharge path A1 branches off and the second discharge path A2 extends in a continuous straight line. Here, too, FIGS. 8a and 8b show the representations for a container with a smaller cross-section and FIGS. 9a and 9b each show the situation for a container with a larger cross-section.

FIG. 10 shows a situation in which a plurality of parallel transport belt tracks are provided. Here, comparatively flat guides or curves are provided.

FIGS. 11a and 11b show an example for a lane width of 70 mm, in which the first discharge path A1 veers upward and is curved in each case. In the situation shown in FIG. 11a, the containers are guided into the second discharge path A2 and in the situation shown in FIG. 11b, the containers are guided into the first discharge path A1.

In the situation shown in FIGS. 11a and 11b, it is also possible to adjust the lane width on both sides. For this purpose, adjustment devices are preferably provided.

Furthermore, FIGS. 11a and 11b each show two stationary wedges 34a and 34b which are spaced apart from one other as far as possible in the situation shown in FIGS. 11a and 11b.

In FIG. 12a, b, a similar situation is shown, but there is a minimal distance between the stationary wedges 34a, 34b. In this way, in the situation shown in FIGS. 12a, b, the lane width can be increased from 70 to 85 mm.

FIG. 13 is a perspective view of the apparatus according to the invention. Four distribution devices 6, 6a, 6b, 6c are provided here. In addition, the drive devices 12, 12a, 12b and 12c are each provided, which are arranged here above the transport path of the containers in this case and which cause the distribution devices to be displaced between the positions P1 and P2, in this case transversely, i.e. in the direction Q.

FIGS. 14a and 14b each show a drive device. The distributor device 6 is shown, which is held here by a rod 132 (in particular in a rotationally fixed manner). Reference sign 128 denotes a carriage which can slide relative to a guide rod 130.

Reference sign 122 denotes a drive device, in particular a linear motor. This is pivotally mounted by a pivoting device 124. Reference sign 126 denotes an articulated connection.

The positions of the distribution device, i.e. positions P1 and P2, are shown in FIGS. 14a, b.

FIGS. 15a, b show a further embodiment of a drive device. This is designed in a similar way to the drive device shown in FIGS. 14a, b, but in this case a toggle lever mechanism 134 is used additionally, which, depending on the direction of movement, causes a very high adjustment speed, particularly at the beginning of an adjustment process (or at the end of the adjustment process). The two positions of this mechanism are shown in FIG. 15a, b.

FIG. 16 shows a further embodiment of a drive device. In this case, a circumferential belt 140, for example a toothed belt, is provided, to which the carriage 128 is fastened, wherein the carriage can slide relative to the guide rod 130.

FIG. 17 shows a further embodiment of the drive device. Here, a spindle 142 is provided, which in turn can drive the carriage 128 between the two positions P1 and P2.

FIG. 18 is a plan view of the apparatus according to the invention. A total of six distribution devices are shown here, which are positioned in this case so that piece goods pass from the supply path or supply region Z to the second discharge path A2.

Reference sign 128 denotes a carriage in each case, which is/are displaceable with respect to the carriers 130. The drive devices, here once again in the form of position-controlled linear motors, are denoted by reference sign 122.

It is to be noted that all features which have been described with reference to the method are also disclosed in a corresponding manner for the apparatus, which means in particular that the corresponding apparatus has devices which are suitable and intended for carrying out the particular methods. Furthermore, features which were described with reference to the apparatus are also correspondingly applicable to the method or methods. This means that the methods are carried out using the corresponding apparatus features.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, a person skilled in the art will recognize that advantages can also result from a combination of several features shown in individual or in different figures.

1. An apparatus for transporting piece goods, comprising a supply device which is suitable for supplying the piece goods along at least one first supply path to a distribution region, wherein said supply device comprises a first transport device which is suitable and intended for moving the piece goods along the supply path, and a discharge device which is suitable for discharging the piece goods along either at least one first discharge path or along one second discharge path, wherein the discharge device comprises at least one transport device which is suitable and intended for moving the piece goods along the first or second discharge path, wherein the apparatus comprises a first distribution device which is movable between at least two positions, wherein the first distribution device is suitable and intended for pushing the piece goods toward the first discharge path when the distribution device is arranged in the first position, and for pushing or guiding the piece goods toward the second discharge path when the first distribution device is arranged in the second position.

2. The apparatus according to claim 1,
characterized in that
the distribution device can move transversely to the transport direction between the first position and the second position.

3. The apparatus according to claim 1,
characterized in that
in one position of the distribution device, a transport lane for transporting the piece goods is formed and extends from the supply path to the first or second discharge path for the piece goods, and, in a second position of the distribution device, a transport lane for transporting the piece goods is formed and extends from the supply path to the second or first discharge path for the piece goods, wherein the distribution device forming, in both positions, at least a section of a limiting wall of each of these transport lanes.

4. The apparatus according to claim 1,
characterized in that
the first distribution device has a first pushing surface which is suitable and intended for pushing the piece goods toward the first discharge path and a second pushing and/or guide surface which is suitable and intended for pushing or guiding the piece goods toward the second discharge path, wherein the first pushing surface and the second pushing and/or guide surface being at least partially spaced apart from one another.

5. The apparatus according to claim 4,
characterized in that
the first pushing surface is suitable and intended for pushing the piece goods into the first discharge path when the distribution device is arranged in the first position and the second pushing and/or guide surface is suitable and intended for pushing or guiding the piece goods into the second discharge path when the distribution device is arranged in the second position.

6. The apparatus according to claim 4,
characterized in that
a distance between the first pushing surface and the second pushing surface increases in the transport direction of the piece goods and/or the distribution device is wedge-shaped.

7. The apparatus according to claim 1,
characterized in that
at least one of the positions is adjustable.

8. The apparatus according to claim 4,
characterized in that
in one position of the distribution device, at least one pushing and/or guide surface acts as a guiding surface which delimits the transport path of the piece goods transversely to the transport direction.

9. The apparatus according to claim 1,
characterized in that
the apparatus comprises a drive device which is suitable and intended for moving the distribution device between the first position and the second position.

10. The apparatus according to claim 1,
characterized in that
the apparatus has a second distribution device which is arranged upstream or downstream of the first distribution device in the transport direction of the piece goods, wherein this second distribution device also being movable between a first position and a second position.

11. The apparatus according to claim 1,
characterized in that
the apparatus has at least three distribution devices.

12. The apparatus according to claim 1,
characterized in that
the apparatus has a gap-creating device which is suitable and intended for creating a gap in a stream of transported piece goods.

13. The apparatus according to claim 12,
characterized in that
the apparatus comprises a control device which is suitable and intended for controlling the movement of the distribution device between the first position and the second position, taking into account the activation of the gap-creating device.

14. A method for transporting piece goods, wherein a supply device supplies the piece goods along at least one first supply path to a distribution region, wherein this supply device has a first transport device which moves the piece goods along the supply path, wherein at least one discharge device discharges the piece goods either along at least one first discharge path or along one second discharge path, wherein the discharge device has at least one transport device which moves the piece goods along the first and/or second discharge paths, wherein the apparatus has a first distribution device which is moved between at least two positions, wherein the first distribution device pushes the piece goods toward the first discharge path when the distribution device is arranged in the first position and pushes and/or guides the piece goods toward the second discharge path when the first distribution device is arranged in the second position.

15. The method according to claim 14,
characterized in that
a second distribution device is also moved between a first position and a second position, wherein the movement of the second distribution device being carried out independently of the movement of the first distribution device.
